(19) United States
(12) Patent Application Publication
(10) Pub. No.: US 2020/0070727 A1
(43) Pub. Date: Mar. 5, 2020

(54) VEHICLE IMAGING UNIT

(71) Applicant: HONDA MOTOR CO., LTD., Tokyo (JP)

(72) Inventor: Makoto Sawada, Wako-shi (JP)

(21) Appl. No.: 16/517,874

(22) Filed: Jul. 22, 2019

(30) Foreign Application Priority Data
Aug. 28, 2018 (JP) 2018-159706

(51) Int. Cl. B60R 1/00; B60R 11/02; B60R 11/04

(52) U.S. Cl. CPC B60R 1/002; B60R 2300/802; B60R 11/04; B60R 11/0235

(57) ABSTRACT

A vehicle imaging unit includes an imaging device and a housing. The imaging device images the surroundings of a vehicle. The housing accommodates the imaging device and is attached to a side portion of a vehicle body. The housing includes an inner housing attached to the side portion of the vehicle body, and an outer housing disposed outside the inner housing in a vehicle width direction. The outer housing is detachably attached to the inner housing.

### CROSS-REFERENCE TO RELATED APPLICATION

Priority is claimed on Japanese Patent Application No. 2018-159706, filed on Aug. 28, 2018, the contents of which are incorporated herein by reference.

### BACKGROUND

### Field of the Invention

The present invention relates to a vehicle imaging unit including an imaging device for imaging the rear of a side portion of a vehicle.

### Background

A technique in which an imaging unit (a camera) having an imaging device for imaging the rear from a side portion of a vehicle and a monitor for displaying images captured by the imaging device are integrated, and the integrated monitor unit is attached to a triangular window portion on a front portion of a front side door (see Published Japanese Translation No. 2013-520363 of the PCT International Publication) is known.

In the monitor unit described in Published Japanese Translation No. 2013-520363 of the PCT International Publication, the monitor is disposed in a vehicle interior, and the imaging unit is disposed outside the vehicle interior in a state where the monitor unit is attached to the triangular window portion of the front side door. An imaging lens of the imaging unit is provided on a rear surface of a housing such that an optical axis of the imaging lens is directed to the rear of the side portion of the vehicle.

### SUMMARY

In the monitor unit described in Published Japanese Translation No. 2013-520363 of the PCT International Publication, the imaging device is accommodated in the housing of the imaging unit disposed outside the vehicle. However, when maintenance of components accommodated inside the housing such as the imaging device is performed, the entire housing must be removed from the vehicle. For this reason, an improvement of maintainability for the components in the housing is desired.

An aspect of the present invention provides a vehicle imaging unit which can improve maintainability for components in a housing.

A vehicle imaging unit according to an aspect of the present invention includes: an imaging device which images the surroundings of a vehicle; and a housing which accommodates the imaging device and is attached to a side portion of a vehicle body, in which the housing includes an inner housing attached to the side portion of the vehicle body, and an outer housing disposed outside the inner housing in a vehicle width direction, and the outer housing is detachably attached to the inner housing.

According to the above configuration, at the time of maintenance of the components in the housing, maintenance work can be easily performed on the components in the housing from the outside in the vehicle width direction by removing only the outer housing.

A dividing boundary portion between the inner housing and the outer housing may be disposed on at least an upper surface of the housing to extend linearly substantially in a longitudinal direction of the vehicle.

In this case, since the dividing boundary portion between the inner housing and the outer housing extends substantially in the longitudinal direction of the vehicle body on at least the upper surface of the housing, a traveling airflow can smoothly flow to the rear side of the vehicle along the division boundary when the vehicle is traveling. Further, even if dust or water accumulates in the dividing boundary portion on the upper surface of the housing, the dust or water can be discharged outside due to the traveling airflow flowing along the dividing boundary portion when the vehicle is traveling. Therefore, by adopting this configuration, it is possible to prevent accumulation of dust and water at the dividing boundary portion of the housing.

A rear imaging device that is an imaging device for imaging the rear from the side portion of the vehicle may be accommodated in the housing, and a first lens exposure hole for exposing an imaging lens of the rear imaging device to the outside may be provided in the outer housing.

In this case, when the outer housing is removed from the inner housing, a circumferential area of the imaging lens of the rear imaging device is exposed to the outside so that maintenance around the rear imaging device can be easily performed.

A lower imaging device that is an imaging device for imaging a downward from the side portion of the vehicle may be accommodated in the housing, and a second lens exposure hole for exposing an imaging lens of the lower imaging device to the outside may be provided at a position outside the inner housing in the vehicle width direction in the housing.

In this case, since the imaging lens of the lower imaging device is disposed outside the inner housing in the vehicle width direction, maintenance around the lower imaging device can be easily performed when the outer housing is removed from the inner housing.

The dividing boundary portion may be positioned outside a widthwise center of the housing in the vehicle width direction.

In this case, since a volume of the outer housing for closing an outer portion of the inner housing in the vehicle width direction is reduced, the appearance viewed from the outside is improved. In addition, even if the outer housing comes into contact with an external object or the like and falls off, it is possible to reduce deterioration of the appearance viewed from the outside.

Outer surfaces on one side and the other side of the housing sandwiching the dividing boundary portion may be made to have colors different from each other.

In this case, the appearance viewed from the outside is improved, and an operator can easily ascertain the dividing boundary portion when the outer housing is attached to and detached from the inner housing. For this reason, the workability at the time of attaching or detaching the outer housing is improved.

An outer surface of the inner housing and an outer surface of the outer housing may be formed by a continuous surface with the dividing boundary portion interposed therebetween.

In this case, since no step is formed on the outer surfaces of the inner housing and the outer housing between which the dividing boundary portion is interposed, the appearance viewed from the outside is improved, and a large load is less likely to be generated on the housing or an attaching portion of the housing when the housing receives a wind from the outside. Therefore, by adopting this configuration, damage or deterioration of the housing due to a strong wind can be prevented.

The housing may further include a bottom housing detachably attached across lower walls of the inner housing and the outer housing, and the second lens exposure hole may be provided in the bottom housing.

In this case, when the bottom housing is removed from the inner housing, the circumferential area of the imaging lens of the lower imaging device is exposed to the outside so that maintenance around the lower imaging device can be easily performed.

According to the aspect of the present invention, since components in the housing can be accessed from the outer side in the vehicle width direction by removing only the outer housing, maintainability of the components in the housing can be improved.

### BRIEF DESCRIPTION OF THE DRAWINGS

FIG. 1 is a perspective view showing a vehicle interior of a vehicle according to an embodiment of the present invention.

FIG. 2 is a side view of the vehicle according to the embodiment of the present invention.

FIG. 3 is a top view of the vehicle according to the embodiment of the present invention.

FIG. 4 is a front view of the vehicle according to the embodiment of the present invention.

FIG. 5 is a rear view of the vehicle according to the embodiment of the present invention.

FIG. 6 is a view showing a display of a monitor of a rear display system according to the embodiment of the present invention.

FIG. 7 is a top view of an imaging unit according to the embodiment of the present invention.

FIG. 8 is a bottom view of the imaging unit according to the embodiment of the present invention.

FIG. 9 is a front view of the imaging unit according to the embodiment of the present invention.

FIG. 10 is a side view of the imaging unit according to the embodiment of the present invention.

FIG. 11 is a rear view of the imaging unit according to the embodiment of the present invention.

FIG. 12 is a perspective view of the imaging unit according to the embodiment of the present invention.

FIG. 13 is a cross-sectional view of the imaging unit according to the embodiment of the present invention taken along line XIII-XIII of FIG. 11.

FIG. 14 is a cross-sectional view of the imaging unit according to the embodiment of the present invention taken along line XIV-XIV in FIG. 11.

### DESCRIPTION OF EMBODIMENTS

Hereinafter, embodiments of the present invention will be described with reference to the drawings. Also, forward and rearward, upward and downward, and left and right in the following description mean forward and rearward, upward and downward, and the left and the right in the vehicle unless otherwise indicated. In addition, an arrow UP indicating an upper side of the vehicle, an arrow FR indicating a front side of the vehicle, and an arrow LH indicating a left side of the vehicle are shown at appropriate positions in the drawings.

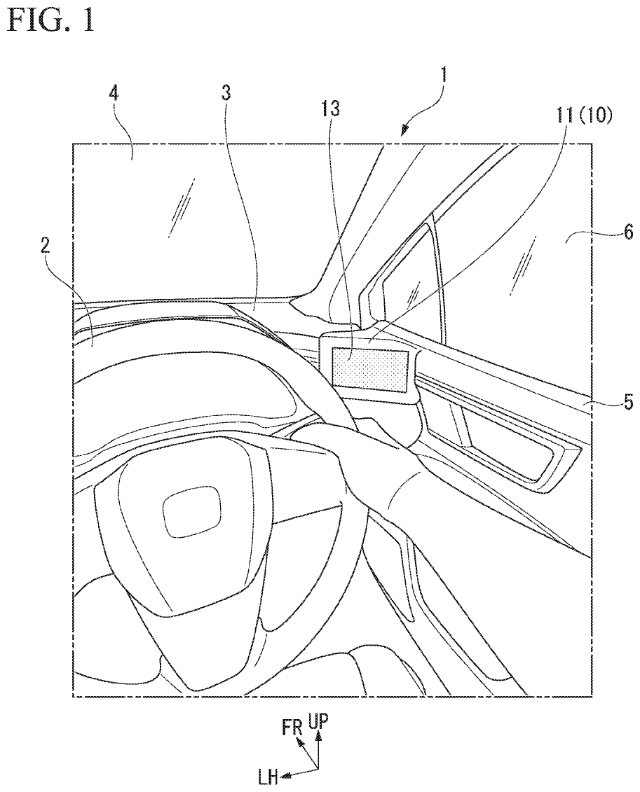

FIG. 1 is a view showing a vehicle interior of a vehicle 1 according to an embodiment. FIG. 1 is a view showing a front portion of front seats (a driver's seat and a front passenger seat) of the vehicle when viewed obliquely from above and to the front.

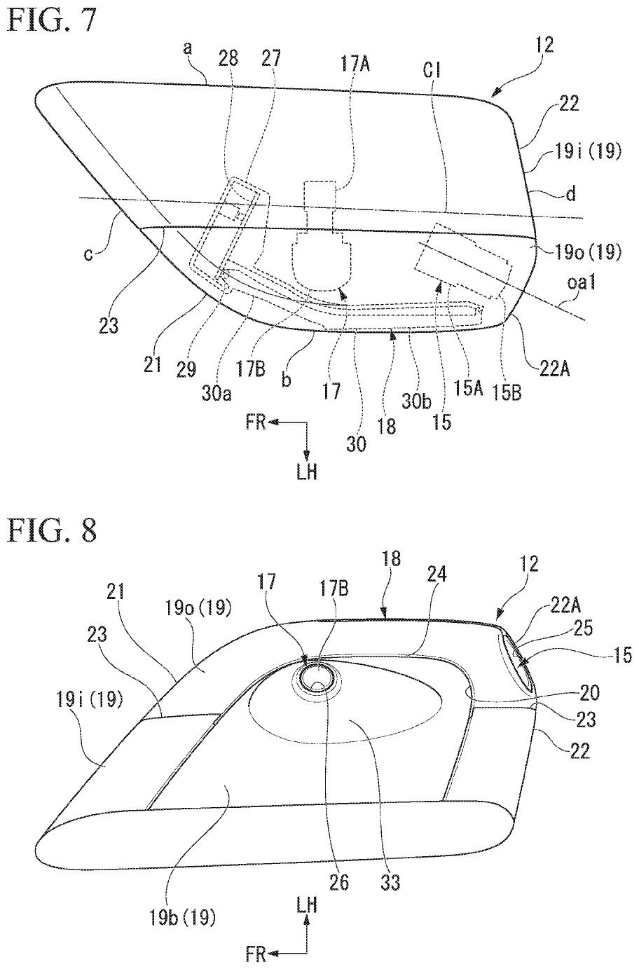

A steering wheel 2 disposed in front of the driver's seat (not shown), an instrument panel 3, a windshield window 4 in front of the vehicle interior, and a front side door (a side door) 5 on the driver's seat side are shown in FIG. 1. A door glass 6 is provided in the front side door 5 to be movable up and down. The vehicle 1 according to the present embodiment is equipped with a rear display system 10 that displays the rear of a side portion of the vehicle in the vehicle interior. The rear display system 10 images left and right sides to the rear of the vehicle by using a rear imaging device 15 (an imaging device; see FIG. 7, etc.) and displays the images on a monitor 11 (a display device) in the vehicle interior.

The rear display system 10 includes rear imaging devices 15 disposed outside left and right front side doors 5, a pair of monitors 11 provided in the vehicle interior corresponding to the left and right rear imaging devices 15, and a control device (not shown) that controls the rear imaging devices 15 and the monitors 11. The monitors 11 corresponding to the left and right rear imaging devices 15 are provided near lower ends of left and right front pillars 7 in the vehicle interior. Images of the left side to the rear of the vehicle are displayed on the monitor 11 at the lower end of the left front pillar 7. Images of the right side to the rear of the vehicle are displayed on the monitor 11 at the lower end of the right front pillar 7.

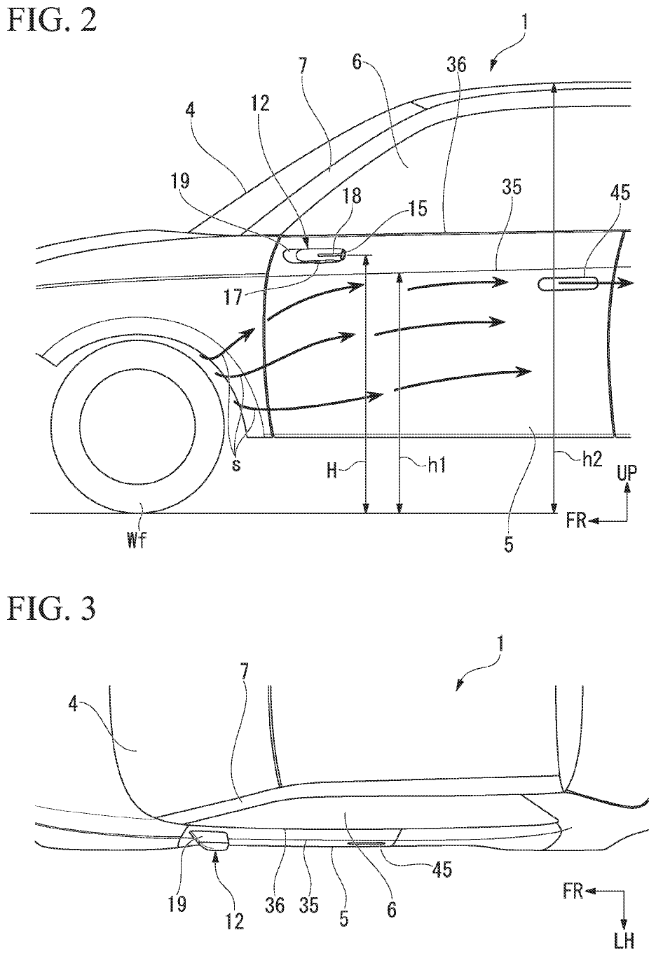

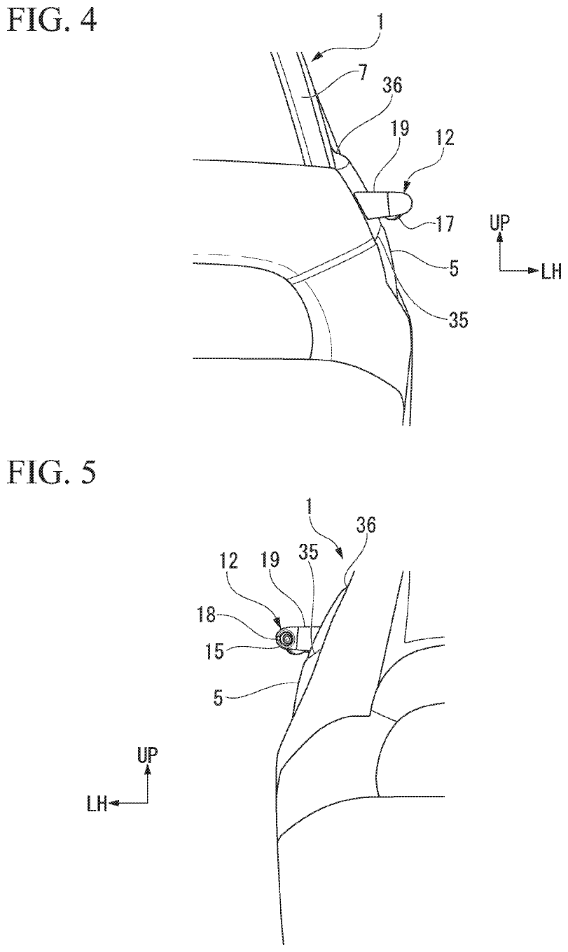

FIG. 2 is a left side view of the vehicle 1. FIG. 3 is a top view of a left half region of the vehicle 1. FIG. 4 is a front view of the left half region of the vehicle 1. FIG. 5 is a rear view of the left half region of the vehicle.

As shown in FIGS. 2 to 5, a vehicle imaging unit 12 (hereinafter referred to as an “imaging unit 12”) incorporating the aforementioned rear imaging device 15 is attached to an outer surface of the left front side door 5. An imaging unit 12 that is the same as the left one is also attached to an outer surface of the right front side door 5.

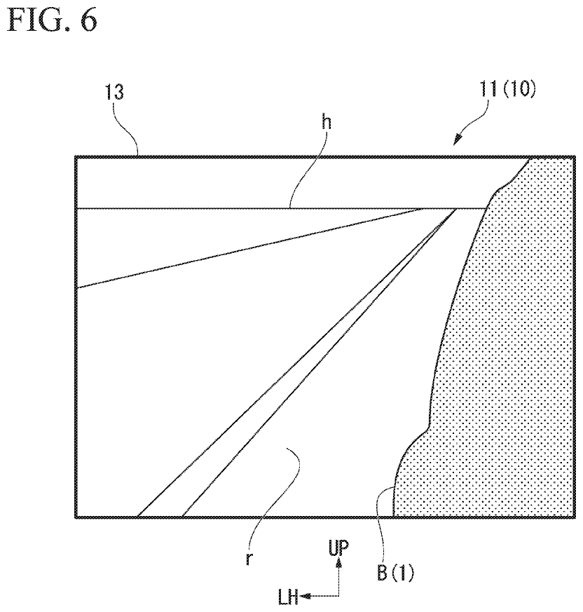

FIG. 6 is a view showing a display screen 13 of the monitor 11 provided in the vehicle interior.

The images of the rear of the side portion taken by the rear imaging device 15 are displayed on the display screen 13 of the monitor 11 together with part of the vehicle body B at the side portion of the vehicle. The display screen 13 is set such that when the vehicle 1 travels on a flat road surface, a horizon line h behind the vehicle and a road surface r a predetermined distance behind the vehicle are simultaneously displayed. Imaging targets to be reflected on the display screen 13 are appropriately set in accordance with a size of the display screen 13, an installation height and a longitudinal position of the rear imaging device 15, an angle of view, or the like. An amount of reflection of the vehicle on the display screen 13 is set to, for example, 10% or less of the entire display screen 13.

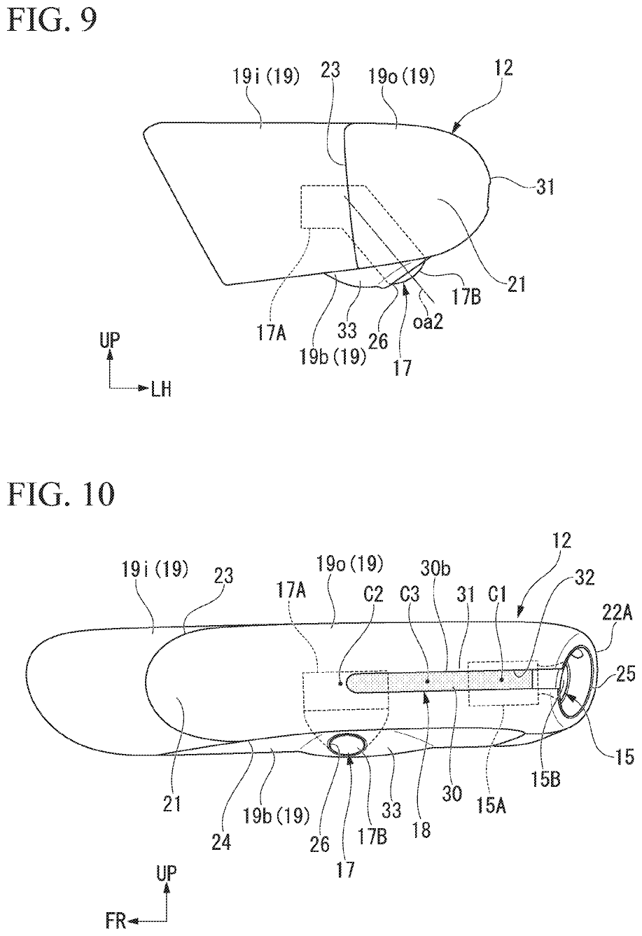

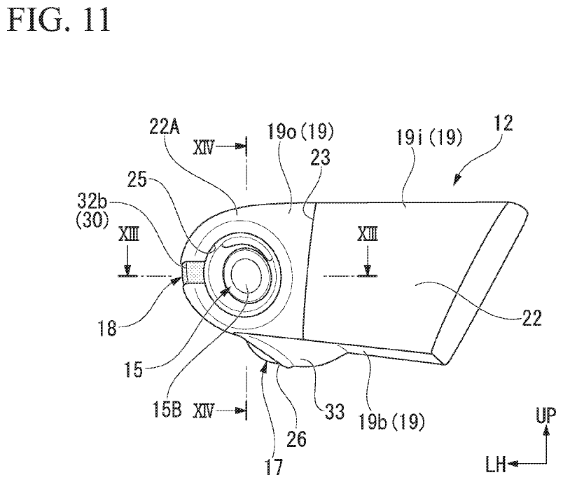

FIG. 7 is a top view of the imaging unit 12 provided in the left front side door 5. FIG. 8 is a bottom view of the imaging unit 12. FIG. 9 is a front view of the imaging unit 12. FIG. 10 is a side view of the imaging unit 12. FIG. 11 is a rear view of the imaging unit 12.

As shown in FIGS. 7 to 11, the imaging unit 12 includes the rear imaging device 15 which images the rear from the side portion of the vehicle, a lower imaging device 17 (an imaging device) which images the downward from the side portion of the vehicle, a lamp unit 18 which constitutes a turn lamp, a side lamp and the like, and a housing 19 which accommodates the rear imaging device 15, the lower imaging device 17, and the lamp unit 18. The housing 19 is attached to the outer surface of the front side door 5 near its front side via a base member (not shown).

The housing 19 includes an inner housing 19i which is attached to the outer surface (the side portion of the vehicle body) of the front side door 5, an outer housing 190 which is assembled on an outer side of the inner housing 19i in the vehicle width direction, and a bottom housing 19b which is assembled on an opening 20 provided at bottom portions of the inner housing 19i and the outer housing 19o. The inner housing 19i, the outer housing 19o, and the bottom housing 19b are detachably assembled together by screw fastening, clip fastening, male and female fitting, or the like. The inner housing 19i, the outer housing 19o, and the bottom housing 19b are made of, for example, a hard resin material.

As shown in FIG. 7, the housing 19 is formed in a substantially trapezoidal shape in a top view, in which a width of an outer side b on the outer side in the vehicle width direction is narrower than that of an inner side a on the inner side in the vehicle width direction attached to the front side door 5. A front end portion of the inner side a and a front end portion of the outer side b are connected by an inclined side c. The inclined side c is inclined outward in the vehicle width direction from the front end portion of the inner side a toward the rear side. The inclined side c and the outer side b are connected by a smooth curve. In the outer surface of the housing 19, the inclined side c, and a portion corresponding to the curved portion connecting the inclined side c and the outer side b are referred to as an inclined region 21 of the housing 19. In the outer surface of the housing 19, a portion corresponding to a side d connecting between rear end portions of the inner side a and the outer side b is referred to as a rear end region 22 of the housing 19.

As shown in FIG. 7, a dividing boundary portion 23 between the inner housing 19i and the outer housing 190 is disposed on an upper surface side of the housing 19. The dividing boundary portion 23 on the upper surface side of the housing 19 extends in a straight line substantially in a longitudinal direction of the vehicle. The dividing boundary portion 23 on the upper surface side of the housing 19 is disposed at a position deviated outward in the vehicle width direction from a center (a center line c1 in FIG. 7) of the housing in the vehicle width direction. In the outer surface of the housing 19, the inner side and the outer side in the vehicle width direction with the dividing boundary portion 23 as a boundary are set to different colors. However, the outer surface of the inner housing 19i and the outer surface of the outer housing 190 are constituted by a smoothly continuous surface with the dividing boundary portion 23 interposed therebetween.

The dividing boundary portion 23 between the inner housing 19i and the outer housing 190 extends toward a lower surface side across the front and rear end portions of the inner housing 19i and the outer housing 19o. On the lower surface of the outer housing 19o, as shown in FIG. 8, the opening 20 is formed to be recessed outward in the vehicle width direction across the dividing boundary portion 23. A portion of the opening 20 of the outer housing 190 recessed outward in the vehicle width direction becomes a dividing boundary portion 24 between the bottom housing 19b and the outer housing 19o. The bottom housing 19b is detachably assembled to both lower walls of the inner housing 19i and the outer housing 19o.

The rear imaging device 15 includes a device main body 15A into which an image sensor and various processing circuits are built, and an imaging lens 15B which captures images of an imaging target. The rear imaging device 15 is disposed at an outer portion of a rear portion of the housing 19 in the vehicle width direction. The imaging lens 15B is exposed to the outside of the vehicle body at an outer portion of a rear end region 22 of the housing 19 in the vehicle width direction. A rear inclined surface 22A which is directed to the rear side of the side portion of the vehicle is provided at an outer portion of the rear end region 22 of the housing 19 (outer housing 19o) in the vehicle width direction. The rear inclined surface 22A is provided with a first lens exposure hole 25 (a lens disposing portion) for exposing the imaging lens 15B to the outside. As shown in FIG. 7, an optical axis oa1 of the imaging lens 15B faces the rear side of the vehicle while being slightly inclined outward in the vehicle width direction.

The lower imaging device 17 is used for a blind monitor system or the like which displays the downward area of the side portion of the vehicle, which is a blind spot from the driver's seat, on a monitor (not shown) on the driver's seat side. The lower imaging device 17 includes a device main body 17A into which an image sensor and various processing circuits are built, and an imaging lens 17B which captures images of an imaging target. The imaging lens 17B is exposed to the outside of the vehicle body on a lower surface of a central region of the housing 19 in the longitudinal direction of the vehicle. A second lens exposure hole 26 for exposing the imaging lens 17B to the outside is provided on a lower surface of the bottom housing 19b. As shown in FIG. 9, an optical axis oa2 of the imaging lens 17B faces the lower side of the vehicle while being slightly inclined outward in the vehicle width direction.

As shown in FIG. 7, the rear imaging device 15 is positioned on a rear side of the vehicle behind the lower imaging device 17 when the housing 19 is viewed from above, and is disposed inside the housing 19 such that an outer end of the imaging lens 15B in the vehicle width direction is positioned outside the lower imaging device 17 in the vehicle width direction. As shown in FIG. 10, the rear imaging device 15 and the lower imaging device 17 are disposed in the housing 19 such that a position of a center c1 of the device main body 15A of the rear imaging device 15 and a position of a center c2 of the device main body 17A of the lower imaging device 17 are substantially horizontal in a state where the housing 19 is attached to a side portion of the front side door 5.

As shown in FIG. 7, the lamp unit 18 includes a base block 27 mounted inside the housing 19, a circuit board 28 held by the base block 27, a lamp 29 such as an LED mounted on the circuit board 28, and an elongated light guide 30 which is held by the base block 27 and guides the light of the lamp 29 to a predetermined portion of the outer surface of the housing 19. The light guide 30 has an inclined portion 30a which extends obliquely outward in the vehicle width direction from the base block 27 toward the rear side of the vehicle body, and a light irradiating portion 30b which extends linearly from a rear end portion of the inclined portion 30a to the rear side of the vehicle.

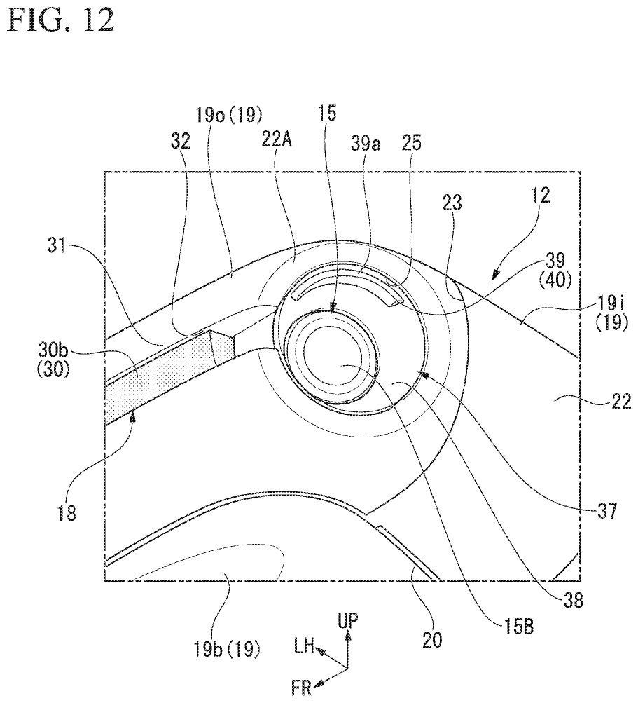

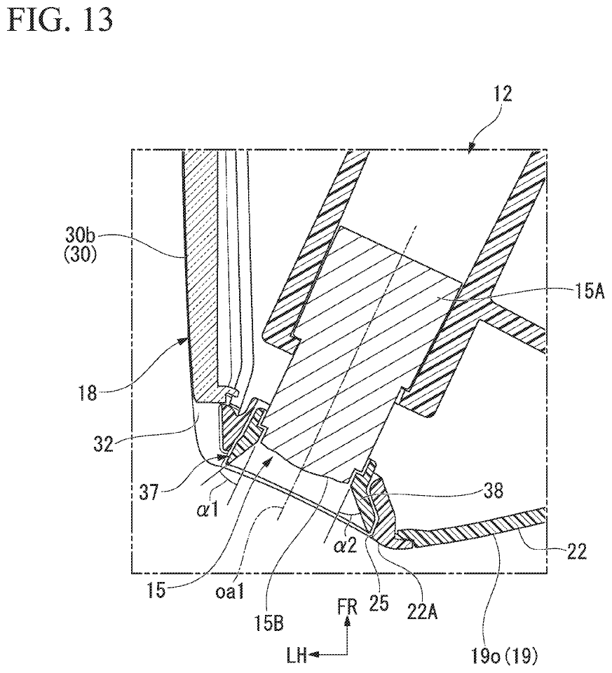

FIG. 12 is a view of the rear end region 22 of the imaging unit 12 when viewed from a side below and outwards therefrom in the vehicle width direction. FIG. 13 is a cross-sectional view taken along line XIII-XIII of FIG. 11.

A side surface of the housing 19 on the outer side in the vehicle width direction is formed by an arc surface curved in the vertical direction. In the side surfaces thereof on the outer side in the vehicle width direction, a groove 32 (a notched portion) having a substantially rectangular cross-section is formed substantially in the longitudinal direction of the vehicle body at a position slightly lower than a maximum protruding portion 31 bulging outward in the vehicle width direction. The light irradiating portion 30b of the light guide 30 of the lamp unit 18 is disposed in the groove 32 of the housing 19. A rear end portion of the light irradiating portion 30b of the light guide 30 is disposed in front of a position facing the rear inclined surface 22A in the groove 32 of the housing 19. That is, the light irradiating portion 30b is not disposed near the rear end portion of the groove 32 of the housing 19. As a result, the light emitted from the light irradiating portion 30b being incident on the imaging lens 15B of the rear imaging device 15 can be prevented in advance.

Also, the rear end portion of the groove 32 of the housing 19 may be closed by a member having no light transparency.

On the other hand, the inclined portion 30a of the light guide 30 of the lamp unit 18, the base block 27, the circuit board 28, the lamp 29 and the like are disposed inside the housing 19. The inclined portion 30a of the light guide 30 is disposed substantially along the inclined region 21 of the outer surface of the housing 19. In the housing 19, the lower imaging device 17 is disposed inside the inclined portion 30a of the light guide 30 in the vehicle width direction. The imaging lens 17B of the lower imaging device 17 is inclined obliquely downward from the device main body 17A toward the outer side in the vehicle width direction. A portion of the imaging lens 17B inclined obliquely downward is disposed inside of the inclined portion 30a of the light guide 30 in the vehicle width direction. As shown in FIG. 10, the lamp unit 18 is disposed in the housing 19 such that a vertical center c3 of the lamp unit 18 is substantially horizontal to the position of the center c1 of the device main body 15A of the rear imaging device 15 and the position of the center c2 of the device main body 17A of the lower imaging device 17 in a state where the housing 19 is attached to the side portion of the front side door 5.

A downwardly bulging convex portion 33 is provided in an outer region of the bottom housing 19b in the vehicle width direction. The convex portion 33 is formed in a spindle shape elongated in the longitudinal direction of the vehicle. The second lens exposure hole 26 for exposing the imaging lens 17B of the lower imaging device 17 below the bottom housing 19b is formed in the convex portion 33. In the convex portion 33, the second lens exposure hole 26 is disposed in a region wider than a width of the second lens exposure hole 26 in the vehicle width direction, for example, in a region twice or more wider than the width of the second lens exposure hole 26 in the vehicle width direction. The convex portion 33 has a region extending toward the rear side of the vehicle behind the second lens exposure hole 26 (imaging lens 17B).

The imaging lens 17B of the lower imaging device 17 is disposed such that an outer surface of the imaging lens 17B is continuous with a surface shape of the convex portion 33 of the bottom housing 19b. The rear end portion of the convex portion 33 converging in a spindle shape is disposed at a position overlapping part of the imaging lens 15B of the rear imaging device 15 in the vehicle width direction.

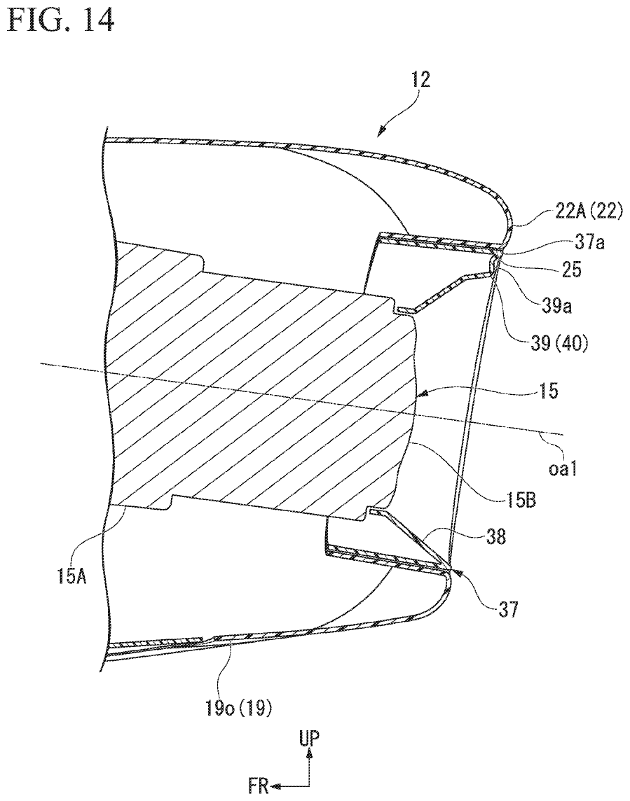

FIG. 14 is a cross-sectional view taken along line XIV-XIV of FIG. 11.

As shown in FIGS. 12 to 14, a lens hood 37 covering a circumferential area of the imaging lens 15B of the rear imaging device 15 is attached to the first lens exposure hole 25 at a rear end of the housing 19 (outer housing 19o). The lens hood 37 has a truncated conical hood wall 38 extending obliquely outward in a radial direction thereof from the circumferential area of the imaging lens 15B toward the imaging direction. An inclination angle of the hood wall 38 relative to the optical axis oa1 of the imaging lens 15B is differently set between an outer area having the groove 32 (notched portion) of the housing 19 and an inner area on a side opposite to the outer area with the optical axis oa1 interposed therebetween.

Specifically, as shown in FIG. 13, an inclination angle α1 of the outer area is set to be larger than an imaging angle of the imaging lens 15B and smaller than an inclination angle α2 of the inner area. In addition, in the circumferential direction of the hood wall 38, an angular difference between the inclination angle α1 of the inner area and the inclination angle α2 of the outer area is the largest, and the inclination angle changes continuously between the inner area and the outer area. The inclination angle of the hood wall 38 with respect to the optical axis oa1 is set such that a radial width of the hood wall 38 appears to be the same in the outer area and the inner area when the housing 19 is viewed from the rear side.

As shown in FIGS. 12 and 14, a stepped portion 39 having a substantially vertical surface 39a directed in the imaging direction is formed in an area above the imaging lens 15B in the hood wall 38 of the lens hood 37 when viewed from a direction of the optical axis oa1 of the imaging lens 15B. The stepped portion 39 is formed by a protrusion 40 protruding in the imaging direction with respect to an inclined surface of the hood wall 38. The protrusion 40 is formed in an arc shape substantially along an outer circumferential edge portion of the hood wall 38 when viewed in the direction of the optical axis oa1.

The protrusion 40 can also be formed in an annular shape when viewed from the direction of the optical axis oa1.

The protrusion 40 (stepped portion 39) is formed to be recessed forward from an outer circumferential end portion 37a (an end portion in an imaging target direction) of the lens hood 37.

The imaging unit 12 of the present embodiment is disposed at a height of the side portion of the vehicle 1 as described below.

This will be described below with reference to FIG. 2. A character line 35 of the side portion of the vehicle body is a convex ridge line portion provided to protrude from the outer surface of the side portion of the vehicle body including the front side door 5 and extends substantially in the longitudinal direction of the vehicle. A door waist portion 36 is an upper side portion of a door body of the front side door 5 and seemingly constitutes a lower side of a window frame portion in which the door glass 6 moves up and down.

The imaging unit 12 is disposed above the height h1 of the character line 35 of the front side door 5 and at a height within a range of 925 mm or more from the ground and a maximum vehicle height h2 or less. For this reason, as shown in FIG. 2, sprays scattered by a front wheel Wf of the vehicle during traveling are blocked by a raised portion of the character line 35 and hardly adhere to the imaging unit 12.

In the case of the present embodiment, since an installation height of the imaging unit 12 is set to 925 mm or more from the ground, halation due to the light of headlights of the next vehicle is less likely to occur. That is, in the present embodiment, since the imaging unit 12 is disposed at a maximum installation height of headlights of general vehicles used on public roads, i.e., 950 mm and at the height of 925 mm or more in consideration of a downward inclination of an optical axis of the headlights, it is possible to inhibit occurrence of halation in the images of the monitor 11 when the light of headlights of the next vehicle directly enters the rear imaging device 15.

In the case of the present embodiment, the imaging unit 12 is disposed at a position below the door waist portion 36 of the front side door 5. For this reason, it becomes difficult for the imaging unit 12 to enter the driver's view through the window frame portion of the front side door 5.

As shown in FIG. 2, a retractable flash door handle 45 is provided at a rear edge portion of the outer surface of the front side door 5. The flash door handle 45 is formed in a horizontally elongated rectangular shape in a side view of the vehicle. The imaging unit 12 attached to a front edge portion of the outer surface of the front side door 5 is formed in a horizontally elongated rectangular shape having the same size and substantially the same shape as those of the flash door handle 45 in a side view of the vehicle. The imaging unit 12 and the flash door handle 45 are disposed at point-symmetrical positions with respect to a centering point on the character line 35 in a side view of the vehicle.

As described above, in the imaging unit 12 according to the present embodiment, the housing 19 which accommodates the rear imaging device 15 and the like includes the inner housing 19i and the outer housing 19o, and the outer housing 190 is detachably attached to the inner housing 19i. For this reason, by removing only the outer housing 19o, the components in the housing 19 can be easily accessed from the outer side in the vehicle width direction. Therefore, in the case of employing the imaging unit 12 according to present embodiment, it is possible to improve the maintainability of the components in the housing 19.

Also, in the imaging unit 12 according to the present embodiment, the dividing boundary portion 23 between the inner housing 19i and the outer housing 190 is provided on at least the upper surface of the housing 19, and the dividing boundary portion 23 thereof linearly extends substantially in the longitudinal direction of the vehicle. For this reason, when the vehicle is traveling, the traveling airflow smoothly flows to the rear side of the vehicle along the dividing boundary portion 23 so that the traveling resistance of the housing 19 can be reduced. In addition, even if dust or water accumulates in the dividing boundary portion 23 on the upper surface of the housing 19, dust and water can be discharged to the outside by the traveling airflow flowing along the dividing boundary portion 23 when the vehicle is traveling. Therefore, in the case of employing this configuration, it is possible to prevent accumulation of dust and water in the dividing boundary portion 23 of the housing 19.

Also, in the imaging unit 12 according to the present embodiment, the first lens exposure hole 25 is provided in the outer housing 19o, and the imaging lens 15B of the rear imaging device 15 is exposed to the outside through the first lens exposure hole 25. For this reason, by removing the outer housing 190 from the inner housing 19i, the circumferential area of the imaging lens 15B of the rear imaging device 15 is exposed to the outside so that maintenance around the rear imaging device 15 can be easily performed.

Further, in the imaging unit 12 according to the present embodiment, the second lens exposure hole 26 is provided at a position outside the inner housing 19i of the housing 19 in the vehicle width direction in the housing 19, and the imaging lens 17B of the lower imaging device 17 is exposed to the outside through the second lens exposure hole 26. For this reason, by removing the outer housing 190 from the inner housing 19i, maintenance around the lower imaging device 17 can be easily performed.

Also, in the imaging unit 12 according to the present embodiment, the dividing boundary portion 23 is provided outside the center (center line c1) of the housing 19 in the vehicle width direction. For this reason, the appearance of the housing 19 viewed from the outside is improved, and even if the outer housing 19 comes into contact with an external object or the like and falls off, it is possible to reduce deterioration of the appearance.

Further, in the imaging unit 12 according to the present embodiment, the outer surface of the housing 19 is set to be different colors with the dividing boundary portion 23 as a boundary. For this reason, not only is the appearance viewed from the outside improved, but also the operator can easily ascertain the dividing boundary portion 23 when the outer housing 190 is attached to and detached from the inner housing 19i. Therefore, by adopting this configuration, it is possible to improve the workability at the time of attaching and detaching the outer housing 19o.

Also, in the case of the imaging unit 12 according to the present embodiment, the outer surface of the inner housing 19i and the outer surface of the outer housing 190 are constituted by a continuous surface with the dividing boundary portion 23 interposed therebetween. For this reason, no step is generated on the outer surface sandwiching the dividing boundary portion 23 between the inner housing 19i and the outer housing 19o. In addition, with the above configuration, the appearance viewed from the outside is improved, and a large load is hardly applied to the housing 19 and the attaching portion of the housing 19 when the housing 19 receives a wind from the outside. Therefore, damage or deterioration of the housing 19 due to a strong wind can be prevented.

Furthermore, the imaging unit 12 according to the present embodiment includes the bottom housing 19b detachably attached across the lower walls of the inner housing 19i and the outer housing 19o, and the second lens exposure hole 26 is provided in the bottom housing 19b. For this reason, by removing the bottom housing 19b from the inner housing 19i, the circumferential area of the imaging lens 17B of the lower imaging device 17 is exposed to the outside so that maintenance around the lower imaging device 17 can be easily performed.

Also, in the imaging unit 12 according to the present embodiment, the dividing boundary portion 24 between the bottom housing 19b and the outer housing 190 is positioned outside the dividing boundary portion 23 between the inner housing 19i and the outer housing 190 in the vehicle width direction. For this reason, when only the outer housing 190 is removed, maintenance work can be performed in a state where the lower imaging device 17 is supported by the bottom housing 19b extending outward in the vehicle width direction over the inner housing 19i. Therefore, in the case of adopting this configuration, the maintenance work of the lower imaging device 17 can be performed more easily.

The present invention is not limited to the above embodiments, and various changes of design can be made without departing from the scope of the present invention.

What is claimed is:

1. A vehicle imaging unit comprising:
an imaging device which images the surroundings of a vehicle; and
a housing which accommodates the imaging device and is attached to a side portion of a vehicle body,
wherein the housing includes an inner housing attached to the side portion of the vehicle body, and an outer housing disposed outside the inner housing in a vehicle width direction, and
the outer housing is detachably attached to the inner housing.

2. The vehicle imaging unit according to claim 1,
wherein a dividing boundary portion between the inner housing and the outer housing is disposed on at least an upper surface of the housing to extend linearly substantially in a longitudinal direction of the vehicle.

3. The vehicle imaging unit according to claim 1,
wherein a rear imaging device which is an imaging device for imaging the rear from the side portion of the vehicle is accommodated in the housing, and
a first lens exposure hole which exposes an imaging lens of the rear imaging device to the outside is provided in the outer housing.

4. The vehicle imaging unit according to claim 1,
wherein a lower imaging device which is an imaging device for imaging a downward from the side portion of the vehicle is accommodated in the housing, and
a second lens exposure hole which exposes an imaging lens of the lower imaging device to the outside is provided at a position outside the inner housing in the vehicle width direction in the housing.

5. The vehicle imaging unit according to claim 2,
wherein the dividing boundary portion is positioned outside a widthwise center of the housing in the vehicle width direction.

6. The vehicle imaging unit according to claim 2,
wherein outer surfaces on one side and the other side of the housing sandwiching the dividing boundary portion are made to have colors different from each other.

7. The vehicle imaging unit according to claim 2,
wherein an outer surface of the inner housing and an outer surface of the outer housing are formed by a continuous surface with the dividing boundary portion interposed therebetween.

8. The vehicle imaging unit according to claim 4,
wherein the housing further includes a bottom housing detachably attached across lower walls of the inner housing and the outer housing, and
the second lens exposure hole is provided in the bottom housing.
